(19) United States
(12) Patent Application Publication
(10) Pub. No.: US 2004/0242040 A1
(43) Pub. Date: Dec. 2, 2004

(54) Card connector with locking device

(76) Inventors: Junichi Miyazawa, Yokohama-shi Kanagawa (JP); Shigeru Akiyama, Tokyo (JP)

Correspondence Address: Stacey E Caldwell, Molex Incorporated, 2222 Wellington Court, Lisle, IL, 60532, US

(21) Appl. No.: 10/482,763

(22) PCT Filed: Jun. 26, 2002
(86) PCT No.: PCT/US02/20228

(30) Foreign Application Priority Data
Jun. 29, 2001 (JP) 2001-199348

(51) Int. Cl. H01R 13/62

(52) U.S. Cl. 439/159

(57) ABSTRACT

A memory card connector includes housing for receiving a generally planar memory card movable in an insertion direction from a preload position to an inserted position. The card has a given thickness. A slider is movably mounted on the housing and is engageable with the memory card for movement therewith between the preload and inserted positions. A lock member is integral with the slider and is engageable with the memory card in a thickness direction of the card to a locking position with a lock portion of the card.

### FIELD OF THE INVENTION

This invention generally relates to the art of electrical connectors and, particularly, to a memory card connector.

### BACKGROUND OF THE INVENTION

Memory cards are known in the art and contain intelligence in the form of a memory circuit or other electronic program. Some form of card reader reads the information or memory stored on the card. Memory cards are used in many applications in today's electronic society, including video cameras, smartphones, music players, ATMs, cable television decoders, toys, games, PC adapters and other electronic applications. A typical memory card includes a contact or terminal array for connection through an electrical connector to a card reader system and then to external equipment. The connector readily accommodates insertion and removal of the card to provide quick access to the information and program on the card. The card connector includes terminals for yieldably engaging the contact or terminal array of the card.

Examples of such card connectors are shown in Japanese Utility Model Application Laid-Open No. Hei 1-75983, Japanese Utility Model Application Laid-Open No. Hei 1-150387 and Japanese Patent Application Laid-Open No. Hei 11-135192.

Some card connectors include a card ejection mechanism whereby the memory card is simply inserted into the connector, and the ejection mechanism is used to facilitate removal of the card from the connector. Some ejection mechanisms include slider members which engage the memory card for movement therewith into and out of the connector. Latches, cams, eject devices and other operative components then are operatively associated with the slider rather than the memory card itself. It is known to provide the ejection mechanism with a latch or lock member which may even be on the slider, itself, engageable with a latch or lock portion of the memory card, such as a cut-out or notch in a side edge of the card. Unfortunately, such locking systems which function generally in the plane of the card create problems because they increase the overall size of the card connector envelope, when miniaturization and size-reduction have become most desirable in memory card connectors. The present invention is directed to providing a locking system of the character described which operates within the envelope of the memory card, itself, and does not significantly increase the size of the card connector.

### SUMMARY OF THE INVENTION

An object, therefore, of the invention is to provide a new and improved memory card connector with an improved card locking system.

In the exemplary embodiment of the invention, the connector includes a housing for receiving a generally planar memory card movable in an insertion direction from a preload position to an inserted position. The memory card has a given thickness. A slider is movably mounted on the housing and is engageable with the memory card for movement therewith between the preload and inserted positions. A lock member is integral with the slider and is engageable with the memory card in a thickness direction of the card. The lock member is engageable in a locking position with a lock portion of the card.

As disclosed herein, the lock member comprises a flexible locking arm integral with the slider. The locking arm is elongated, extends generally parallel to the direction of movement of the memory and slider, and has a locking protrusion at a distal end of the arm. The locking arm overlies a planar side of the memory card and is flexible in the thickness direction of the card.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a top plan view showing the connector housing and an ejection mechanism according to the invention, with the ejection mechanism in a preload position of the memory card;

FIG. 2 is a view similar to that of FIG. 1, with the ejection mechanism in an inserted position of the card;

FIG. 3 is a side elevational view showing the cam mechanism at the right-hand side of the housing as viewed in FIG. 1;

FIG. 4 is a view similar to that of FIG. 3, looking toward the right-hand side of the housing as viewed in FIG. 2;

FIG. 5 is an end elevational view looking at the front insertion end of the connector, with the cover mounted on the housing;

FIG. 6 is a view similar to that of FIG. 5, with the memory card shown shaded and inserted into the connector;

FIG. 7 is a top plan view of the memory card;

FIG. 8 is a side elevational view of the memory card;

FIG. 9 is an enlarged perspective view of the slider;

FIG. 10 is a vertical section taken generally along line 10-10 of FIG. 1;

FIG. 11 is a vertical section taken generally along line 11-11 of FIG. 2;

FIGS. 12(a)-12(d) are various views showing the relationship between the slider and the memory card;

FIG. 13 is a top plan view of a different memory card which does not have a lock portion;

FIG. 14 is a side elevational view of the memory card of FIG. 13; and

FIG. 15 is a view similar to that of FIG. 11, but showing the memory card of FIGS. 13 and 14.

### DETAILED DESCRIPTION OF THE PREFERRED EMBODIMENT

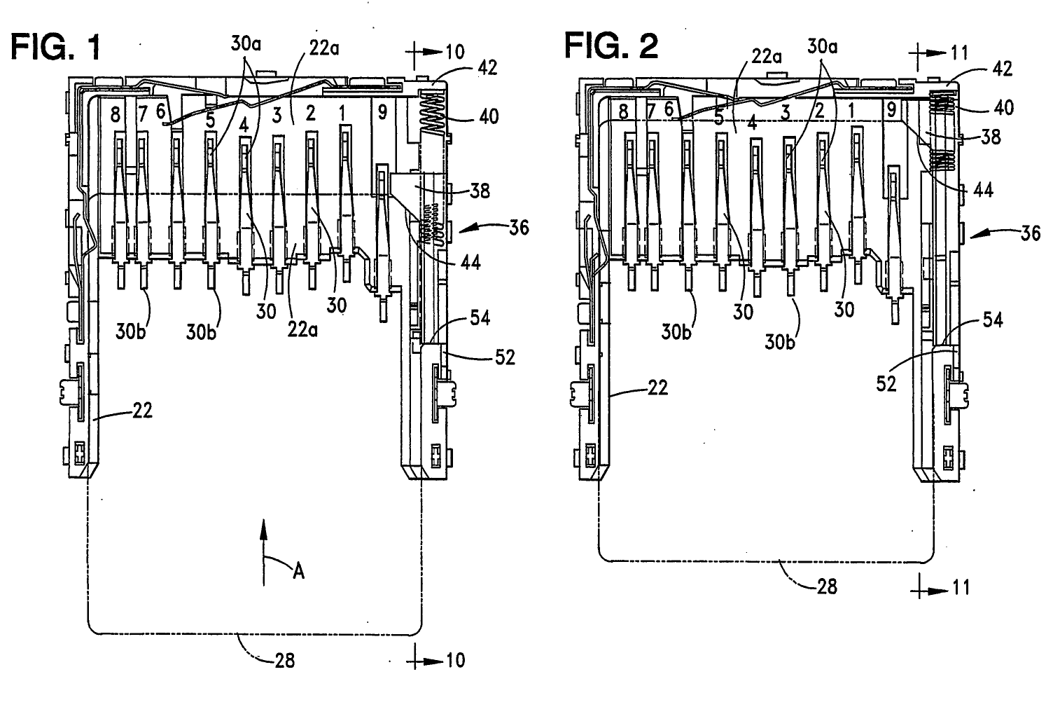

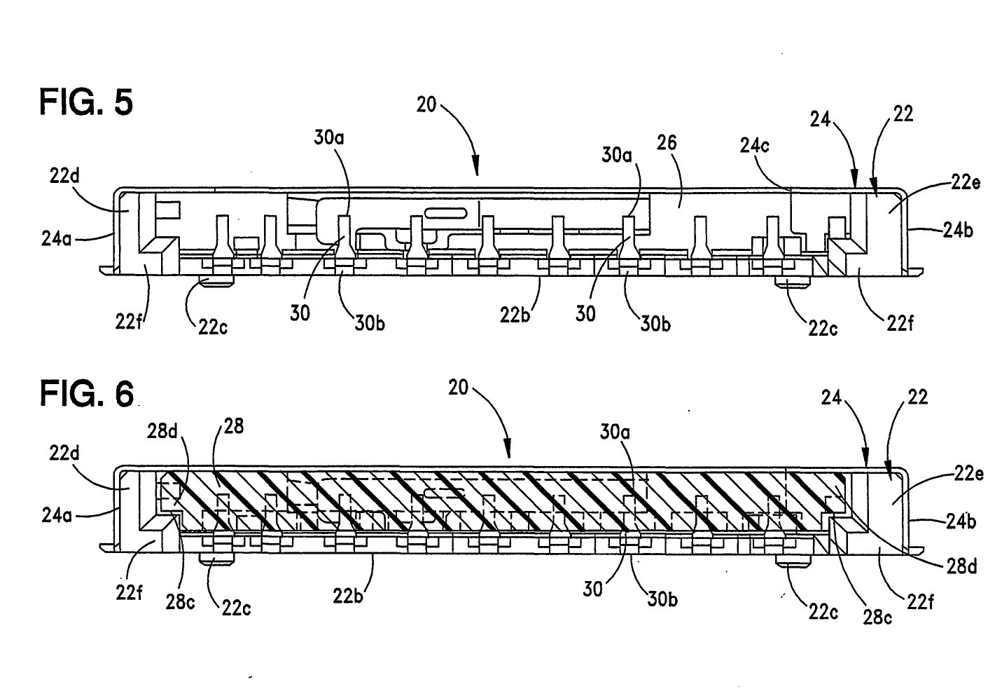

Referring to the drawings in greater detail, and first to FIGS. 1-5, the invention is embodied in a memory card connector, generally designated 20 (FIG. 5), which includes a dielectric housing, generally designated 22, and a sheet metal cover, generally designated 24. The housing and cover define a card-insertion cavity 26 for receiving a memory card 28 in an insertion direction indicated by arrow “A” (FIG. 1).

As best seen in FIGS. 1 and 2, housing 22 includes a body or mounting portion 22a which mounts a plurality of terminals 30. The terminals have flexible contact portions 30a which are exposed within cavity 26 as best seen in FIG. 5. The contact portions engage an array of contacts on memory card 28 as will be seen hereinafter. The terminals also have tail portions 30b for surface connection to appropriate circuit traces on a printed circuit board (not shown). The housing has a bottom wall 22b (FIG. 5) from which a plurality of mounting pegs 22c project downwardly for insertion into appropriate mounting holes in the printed circuit board.

As best seen in FIG. 5, housing 22 includes left and right side walls 22d and 22e, respectively. Cover 24 includes left and right side walls 24a and 24b, respectively, which overlie the side walls of the housing. The cover has a top wall 24c which defines the top of card-insertion cavity 26. Side walls 22d and 22e of the housing are generally L-shaped to define inwardly directed bottom flanges 22f.

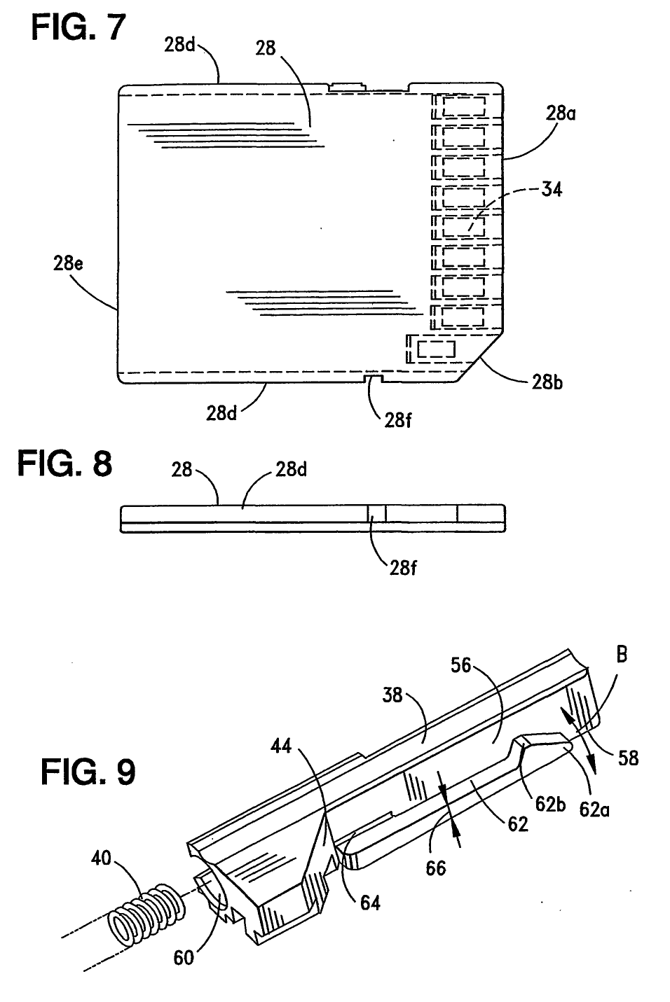

Referring to FIGS. 6-8, memory card 28 has a front or leading edge 28a with an angled corner 28b. The side edges of the memory card are stepped, as at 28c (FIG. 6) to define upper lips 28d which run substantially the length of the card from the leading edge thereof to a rear or trailing edge 28e. The right-hand lip 28d of the card includes a lock portion in the form of a locking notch 28f. A generally transverse row of contacts 34 (FIG. 7) are disposed along the underside of the memory card, generally parallel to leading edge 28a of the card.

When memory card 28 is inserted into card-receiving cavity 26 (FIG. 5) of card connector 20, the stepped configuration of the side edges of the card substantially match the configuration of L-shaped side walls 22d and 22e of housing 22 as best seen in FIG. 6. This prevents the card from being inserted upside-down into the connector. When properly inserted, contacts 34 on the underside of the card engage contact portions 30a of terminals 30.

As seen in FIGS. 1 and 2, the card connector is provided with an ejection mechanism, generally designated 36, which includes a slider 38 with a coil spring 40 located between an inner end of the slider and a wall 42 of the housing. The slider has an angled surface 44 for engaging angled corner 28b (FIG. 7) of the memory card. FIG. 1 shows a preload position of the card and the slider. FIG. 2 shows an inserted position of the card and the slider. The card and slider move in unison between these positions.

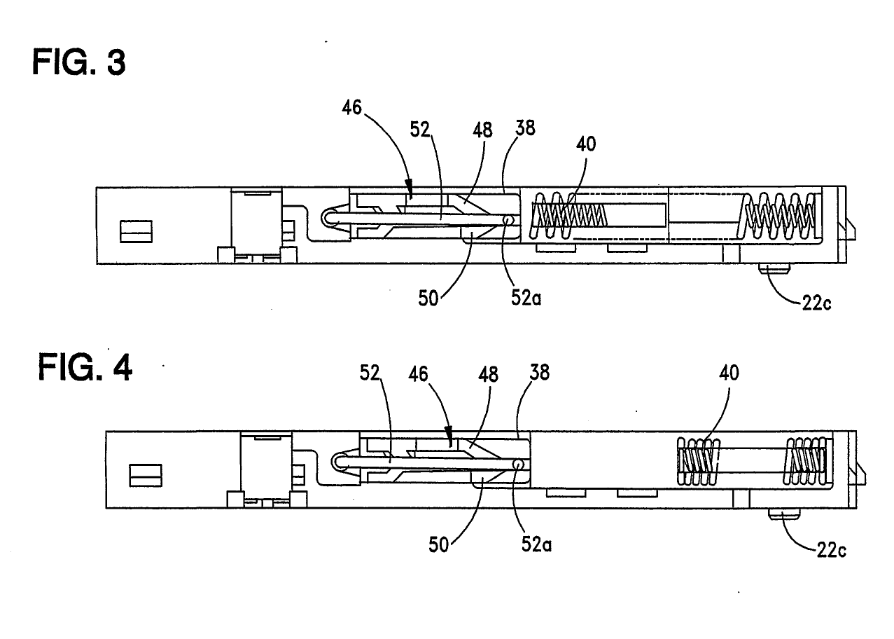

FIGS. 3 and 4 show a “push-push” cam mechanism which regulates the sliding movement of slider 38 as is fairly known in the art. The cam mechanism is provided on an inside surface of the slider and includes a first cam or guide groove 48 and a second cam or guide groove 50 which determine the respective preload and inserted positions of the slider and, therefore, the memory card. A cam follower pin 52 is mounted on the housing and includes a pin portion 52a which rides in the cam grooves of the cam mechanism. The slider is housed within a recessed area 54 (FIGS. 1 and 2) of the housing and is covered by cover 24.

FIG. 9 shows further details of slider 38. In particular, the slider includes a side face 56 and a bottom face 58. An inner end of the slider has a hole 60 for receiving coil spring 44. A flexible locking arm 62 is joined integrally with side face 56 of the slider, as at 64. The locking arm is elongated and extends generally parallel to the direction of insertion and removal of the memory card. The locking arm has a distal end 62a with an upwardly projecting locking protrusion 62b. The distal end of the arm is flexible in the thickness direction of the memory card as indicated by double-headed arrow “B”. The thickness of the flexible locking arm is indicated by the arrows at 66. This thickness is such that the locking arm is totally disposed within the envelope or profile of the stepped side edge of the memory card, as will be seen hereinafter.

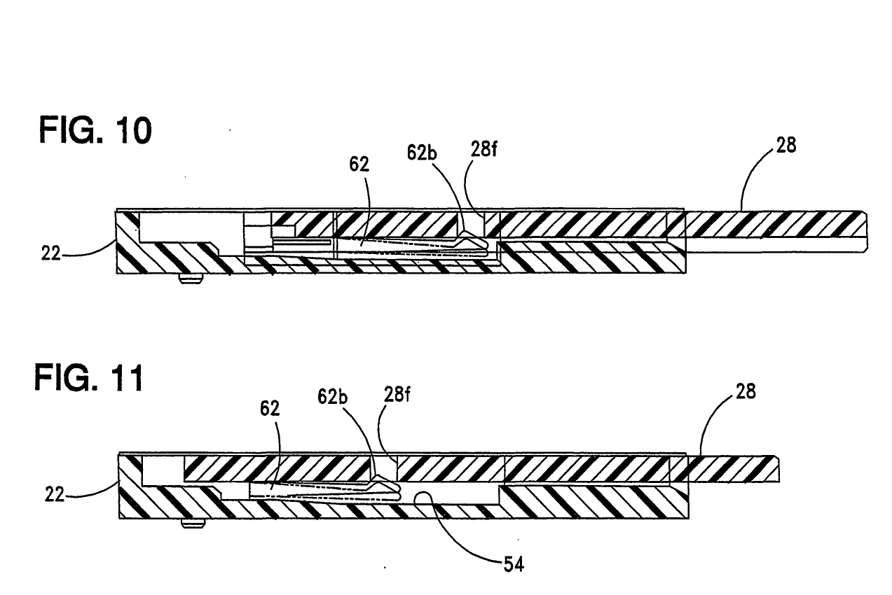

FIGS. 10 and 11 show flexible locking arm 62 with locking protrusion 62b disposed within locking notch 28f of memory card 28. The locking protrusion of the flexible locking arm remains in the locking notch of the memory card whether the card is in its preload position shown in FIG. 10 or its inserted position shown in FIG. 11. In other words, the memory card is locked to slider 38 during movement between those positions.

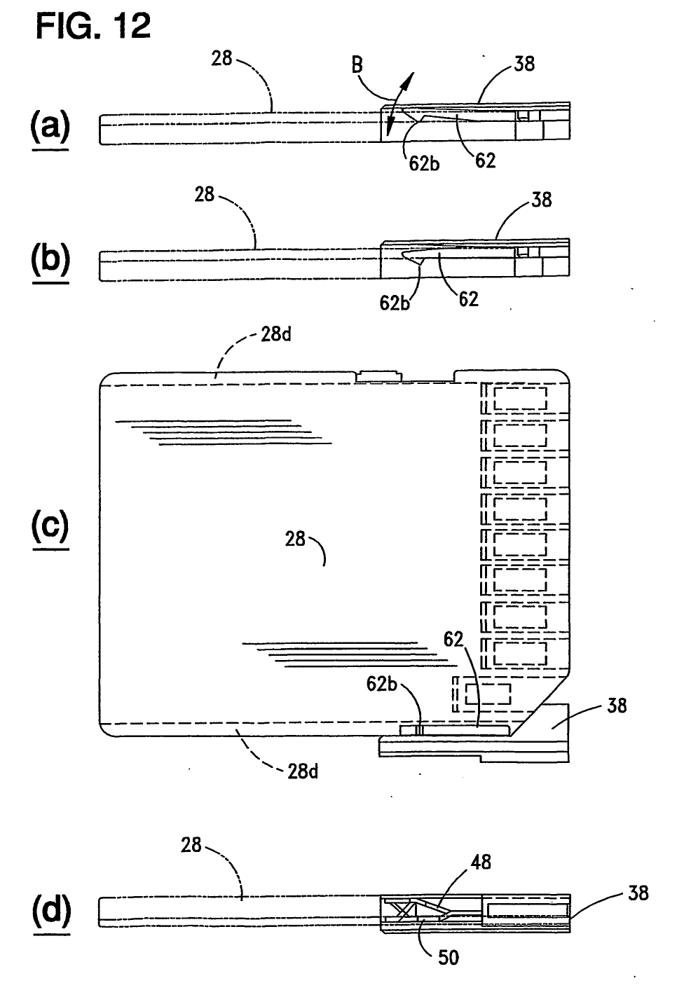

FIGS. 12(a) and 12(b) show that flexible locking arm 62 of slider 38 flexes in the thickness direction of memory 28 as indicated by double-headed arrow “B”. FIG. 12(b) shows somewhat schematically that, when locking protrusion 62b of arm 62 is disposed within the locking notch of the memory card, the locking arm is disposed totally within the thickness profile of the card. Therefore, the provision of a lock member on the slider does not increase the overall envelope of the card connector in the thickness direction thereof.

FIG. 12(c) shows that locking arm 62 and locking protrusion 62b overlie the planar side of the memory card. Specifically, the locking arm is disposed within the recessed area of the card as indicated at 28c in FIG. 6, beneath the right-hand lip 28d of the card. Therefore, the provision of a locking member on slider 38 does not in any way increase the overall lateral dimensions of the card connector.

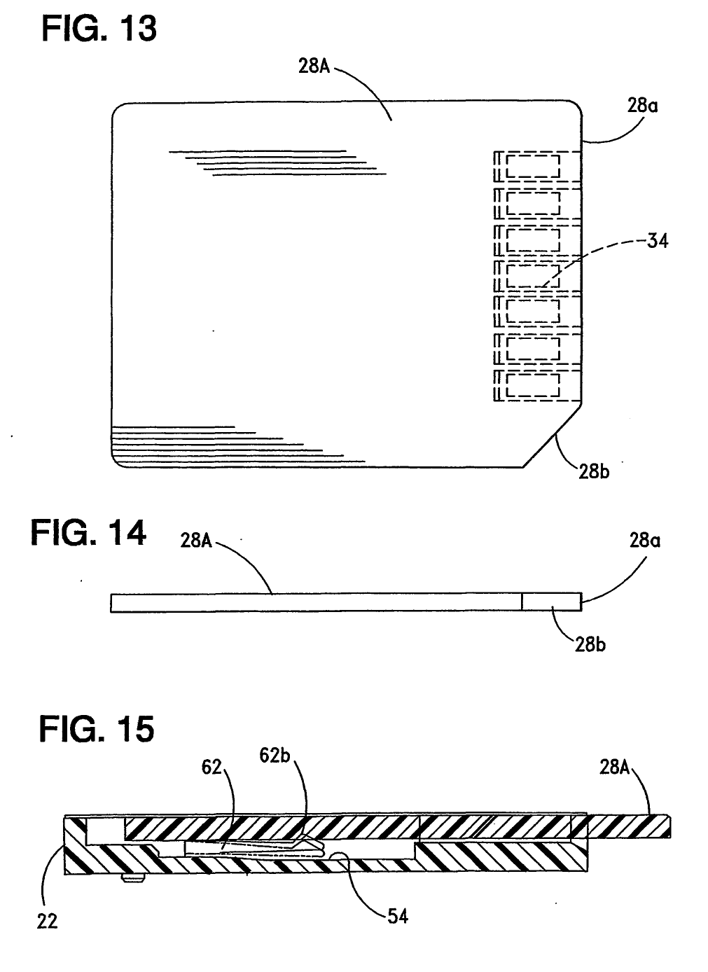

FIGS. 13 and 14 show a memory card 28A which, like memory card 28, has a plurality of contacts 34 along a leading edge 28a of the card, and an angled corner 28b. However, card 28A of FIGS. 13 and 14 does not have a locking notch in the side edge of the card. Nevertheless, FIG. 15 shows that recessed area 54 of housing 22 is sufficient to accommodate flexing of flexible locking arm 62. FIG. 15 shows the locking arm in phantom when locking protrusion 62b cannot enter a locking notch which is not provided on card 28A. Therefore, the card connector herein can accept either memory card 28 or memory card 28A.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A memory card connector (20), comprising:
a housing (22) having a mounting portion (22a) which mounts a plurality of terminals (30) and side walls (22d,22e) which define a cavity (26) for receiving a generally planar memory card (28) movable in an insertion direction (A) from a preload position to an inserted position, die memory card having a given thickness;
a slider (38) movably mounted on the housing (22) and engageable with the memory card for movement with the memory card (28) in its movement between said preload and inserted positions; and,
a flexible locking arm (62) integral with the slider (38) and engageable with a lock portion (28f) of said memory card (28), the flexible arm (62) being elongated and extending generally parallel to the direction (A) of movement of said memory card (28) and slider (38), clwaradtzi?e in that:
the flexible locking arm (62) is flexible in the thickness direction of said memory card (28) and is engageable with the lock portion (28f) of said memory card (28) in the thickness direction of said memory card (28) generally perpendicular to the direction of movement of said memory card (28) and slider (38) to the inserted position.

2. The memory card connector of claim 1, wherein said flexible locking arm (62) has a locking protrusion (62b) at a distal end of said flexible locking am (62).

3. In combination with the memory a connector of claim 1, a memory card (28) having said lock portion (28f) in the form of a notch (28f) in a side edge of said memory card (28).

4. A memory cad connector assembly (20), comprising:
a planar memory card (28) having opposite planar sides and opposite edges with a locking notch (28f) in one of the side edges, the memory card (28) having a given thickness;
a housing (22) having a mounting portion (22a) which mounts a plurality of terminals (30) and side walls (22d,22e) which define a cavity (26) for receiving said memory card (28) movable in an insertion direction from a preload position to an inserted position; and,
a slider (38) movably mounted on the housing (22) and engageable with said memory card (28) for movement with said memory card (28) in its movement between said preload and inserted positions; characterized in that;
a flexible locking arm (62) is integral with the slider (38) and is engageable with said memory card (28) in a thickness direction of said memory card (28) to a locking position with the locking notch (28f) of said memory card (28), the flexible locking arm (62) being flexible in the thickness direction of said memory card (28) generally perpendicular to the direction of movement of said memory card (28) and slider (38) and overlying a planar side of said memory card (28).

5. The memory card connector assembly of claim 4, wherein said flexible locking mm (62) has a locking protrusion (62b) at a distal end of the arm.

6. The memory card connector assembly of claim 4, wherein said flexible locking arm (62) is elongated and extends generally parallel to the direction (A) of movement of said memory card (28) and slider (38).
